(19) United States
(12) Patent Application Publication
(10) Pub. No.: US 2025/0364169 A1
(43) Pub. Date: Nov. 27, 2025

(54) PANEL, FASTENING CONSTRUCTION, AIRCRAFT AND OPENING DEVICE

(71) Applicant: Airbus Defence and Space GmbH, Taufkirchen (DE)

(72) Inventors: Arne Bethge, Taufkirchen (DE); Sebastian Peters, Taufkirchen (DE)

(21) Appl. No.: 18/639,279

(22) Filed: Apr. 18, 2024

(30) Foreign Application Priority Data
Apr. 27, 2023 (DE) 102023110830.1

(51) Int. Cl. H01F 7/20; B64D 7/00; B64D 47/00

(52) U.S. Cl. CPC H01F 7/204; B64D 7/00; B64D 47/00

(57) ABSTRACT

The disclosure herein relates to a panel including an electro-permanent magnet integrated in the panel, and an induction coil connected to the electro-permanent magnet to conduct current induced in the induction coil to the electro-permanent magnet such that the electro-permanent magnet can be switched between a magnetic state and a non-magnetic state. The disclosure herein further relates to a fastening construction, to an aircraft and to an opening device.

### TECHNICAL FIELD

The disclosure herein relates to a panel, to a fastening construction, to an aircraft and to an opening device.

### BACKGROUND

When components, in particular electronic components, are installed in walls, it is often necessary to still provide access to the components. For this purpose, access hatches or panels are used which can easily be detachably connected to the rest of the wall in order to ensure relatively easy access to components located in the wall. When it comes to fastening means, screws or similar fasteners are often used as the simplest solution.

Since the fastening means used generally have to be accessible from the surface of the wall so that they can be opened, the panels used can sometimes have a complex design when specific requirements are imposed on the surface design.

In aircraft, this can be the case for example when the access panel is located on an outer shell of the aircraft, since in this case the aerodynamic properties of the aircraft should not be impaired by the access panel. Some aircraft, often in the military sector, are additionally provided with surface structures which have camouflage properties with respect to various sensors. The properties of such structures should also not be impaired by access panels.

### SUMMARY

Accordingly, the disclosure herein addresses the problem of providing a fastening mechanism for access panels which allows any desired design of the surface shape.

This problem is solved by a panel, a fastening construction, an aircraft, and an opening device disclosed herein.

According to a first aspect of the disclosure herein, a panel is provided comprising an electro-permanent magnet which is integrated in the panel, and an induction coil which is connected to the electro-permanent magnet and is designed to conduct current induced in the induction coil to the electro-permanent magnet in such a way that the electro-permanent magnet can be switched between a magnetic state and a non-magnetic state.

According to another aspect of the disclosure herein, a fastening construction is provided comprising a panel according to the disclosure herein and a base element having a ferromagnet which is designed to connect the panel to the base element when the electro-permanent magnet of the panel is in the magnetic state.

According to another aspect of the disclosure herein, an aircraft is provided comprising a fastening construction according to the disclosure herein.

According to another aspect of the disclosure herein, an opening device for a panel according to the disclosure herein is provided comprising at least one receiving element which is designed to produce a detachable connection to the panel, an electrical energy source, and an induction coil which is connected to the electrical energy source and is designed to induce a current in the induction coil of the panel when the at least one receiving element is connected to the panel. One concept on which the disclosure herein is based consists in the use of an electro-permanent magnet for fastening the panel to the base element. An electro-permanent magnet is a magnet having an external magnetic effect that can be switched on and off by a current pulse. For this purpose, an electromagnet having a core made of magnetically semi-hard material and a permanent magnet are generally used. If the semi-hard core is magnetized in the opposite direction to the hard core of the permanent magnet, then the external magnetic effects thereof cancel each other out. If the semi-hard core is magnetized in the same direction as the permanent magnet, then an external magnetic effect is present. It is also conceivable to use an electro-permanent magnet which comprises a permanent magnet and an electromagnet, the electromagnet being oriented in such a way that, during operation, it neutralizes the magnetic field of the permanent magnet in such a way that no external magnetic field occurs.

In both cases, electrical energy is required only to switch between the two states, and therefore the fastening construction does not require an energy source and can be kept in the fastened state for unlimited periods of time. Since the energy used to open and close the panel is transferred in a contactless manner, no surface elements are required for fastening, and therefore the surface can be designed independently of the opening and closing mechanism.

According to one example embodiment of the panel, the induction coil is integrated in the panel. As a result, the surface of the panel can advantageously be designed as required.

According to another example embodiment, the panel has an external mark which indicates the position of the induction coil. As a result, opening and closing the panel can advantageously be made easier.

According to another example embodiment of the panel, the external mark is in the form of a surface structure. As a result, opening and closing the panel can advantageously be made easier.

According to one example embodiment of the fastening construction, the base element has a recess which is adapted to the shape of the panel. This results in an advantageously highly customizable surface of the entire fastening construction.

According to another example embodiment of the fastening construction, the recess is designed in such a way that a surface of the panel is positively connected to a surface of the base element when the panel is arranged in the recess. This results in an advantageously highly customizable surface of the entire fastening construction.

According to another example embodiment of the fastening construction, the surface of the panel and the surface of the base element have a camouflage surface structure. This is a particularly advantageous design of the fastening construction.

### BRIEF DESCRIPTION OF THE DRAWINGS

The disclosure herein will be described in the following with reference to the drawings, in which:

FIG. 1 is a schematic view of an aircraft according to one example embodiment of the disclosure herein;

FIG. 2 is a schematic view of a panel according to one example embodiment of the disclosure herein;

FIG. 3 is a schematic cross-sectional view of a fastening construction according to one example embodiment of the disclosure herein; and

FIG. 4 is a schematic view of an opening device according to one example embodiment of the disclosure herein.

In the drawings, the same reference signs denote like or functionally like components, unless stated otherwise.

### DETAILED DESCRIPTION

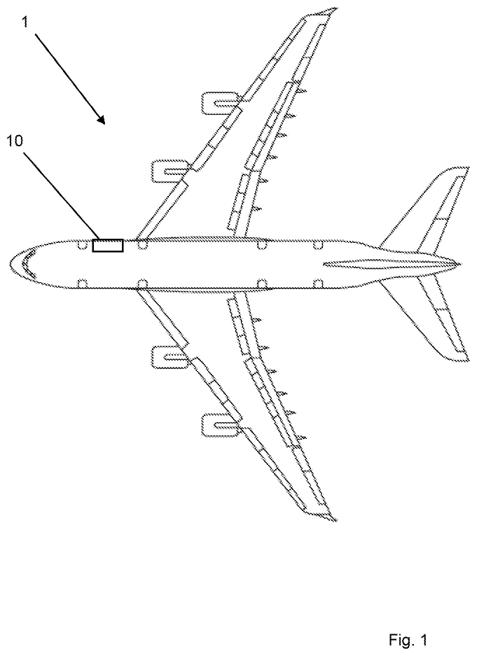

FIG. 1 is a schematic view of an aircraft 1 according to one example embodiment of the disclosure herein.

The aircraft vehicle 1 has a fastening construction 10. The fastening construction 10 is described in detail with reference to the following drawings.

In FIG. 1, the fastening construction 10 is arranged on an outer shell of the aircraft 1. In this position, a fastening construction 10 having the features of the disclosure herein can be used particularly advantageously. However, a fastening construction 10 according to the disclosure herein can be used in any conceivable position of an aircraft 1 or of another aircraft or even of a building.

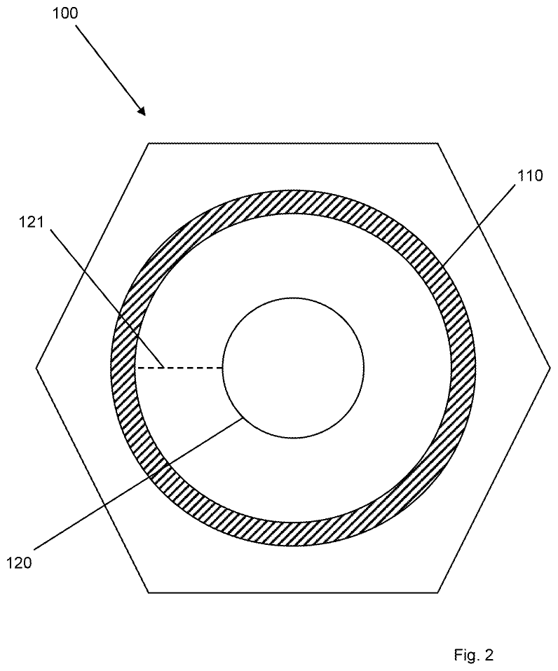

FIG. 2 is a schematic view of a panel 100 according to one example embodiment of the disclosure herein.

The panel 100 comprises an electro-permanent magnet 110 and an induction coil 120. The electro-permanent magnet 110 is integrated in the panel 100. The induction coil 120 is connected to the electro-permanent magnet 110 by an electrical connection 121. By the electrical connection 121, the induction coil 120 can conduct current induced therein to the electro-permanent magnet 110. By this current, the electro-permanent magnet 110 can be switched between a magnetic state and a non-magnetic state.

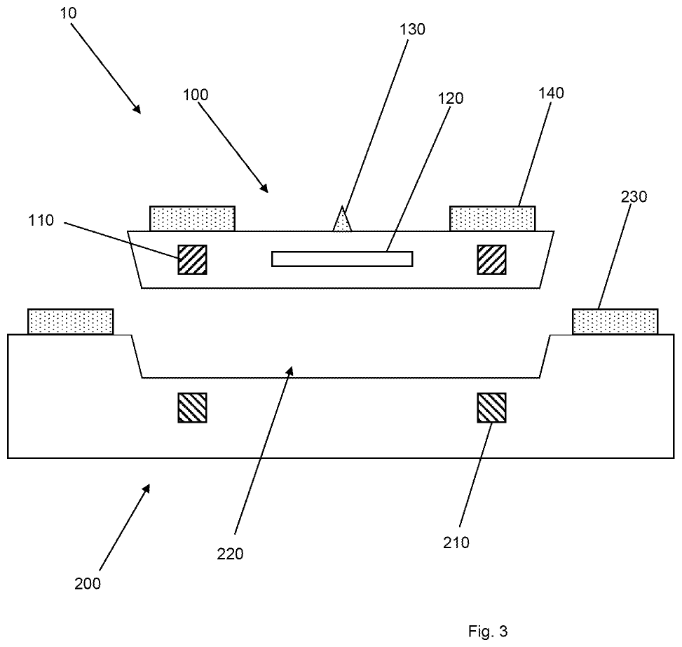

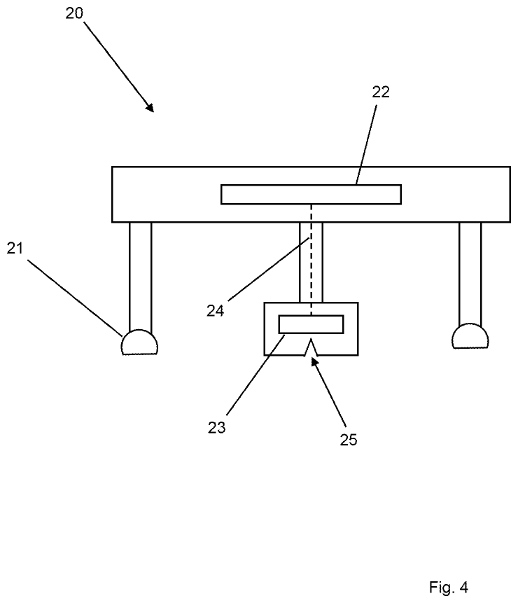

The precise function of the individual features of the panel 100 are described in greater detail in the following with reference to FIGS. 3 and 4.

FIG. 3 is a schematic cross-sectional view of a fastening construction 10 according to one example embodiment of the disclosure herein.

The fastening construction 10 comprises a panel 100 and a base element 200. The panel 100 has the same features as the panel shown in FIG. 2. The induction coil 120 is integrated in the panel 100, wherein the panel 100 has an external mark 130 which is in the form of a surface structure and which indicates the position of the induction coil 120. The base element vehicle 200 has a ferromagnet 210. The ferromagnet 21 is designed to connect the panel 100 to the base element 200 when the electro-permanent magnet 110 of the panel 100 is in the magnetic state.

While the electro-permanent magnet 110 of the panel 100 is in a magnetic state, the magnetic pull between the electro-permanent magnet 110 and the ferromagnet 210 of the base element 200 ensures that the panel 100 stays rigidly connected to the base element 200. When a current pulse is induced in the induction coil 120 of the panel 100, this current pulse is transmitted to the electro-permanent magnet 110, as a result of which the electro-permanent magnet is switched to the non-magnetic state. Since there is no longer any magnetic pull between the panel 100 and the base element 200, the panel 100 can easily be removed. At a later point in time, the panel 100 can be brought back into position, and the electro-permanent magnet 110 can be switched back to the magnetic state by inducing a new current pulse in the induction coil 120, as a result of which the connection between the panel 100 and the base element 200 is restored. In this case, the ferromagnet 210 itself can be in the form of a permanent magnet or can merely be attracted by the electro-permanent magnet 110 which is in a magnetic state. By way of example, the ferromagnet 210 can consist of iron. In the case of an electro-permanent magnet 110 which is in the magnetic state when it is not supplied with current and is in the non-magnetic state when it is supplied with current, current is induced through the induction coil 120 for the entire opening process.

The base element 200 has a recess 220 which is adapted to the shape of the panel 100 and is designed in such a way that a surface of the panel 100 is positively connected to a surface of the base element when the panel 100 is arranged in the recess 220. In the example embodiment shown here, both the panel 100 and the recess 220 have a trapezoidal cross section. However, the fastening construction according to the disclosure herein is not limited to such cross-sectional shapes. By the positive connection of the surfaces of the panel 100 and the base element 200, the surface properties, for example the aerodynamic properties, can advantageously be coordinated, since the magnets 110, 210 for fastening the panel 100 to the base element 200 are not located on the surface and therefore can be ignored for the design of each of the surfaces.

The external mark in the form of a surface structure 130 is used to indicate the position of the induction coil 120 so that a current can be reliably induced in the induction coil 120. In the present example embodiment, the external mark 130 consists of a pyramid-shaped structure which is arranged so as to be centred over the induction coil 120. An external mark 130 could also be arranged in an annular shape covering the induction coil 120 or could have any other desired shape. Instead of a surface structure, coloured marks can also be provided.

The surface of the panel 100 and the surface of the base element 200 each have a camouflage surface structure 140 and 230. This is a particularly advantageous design which is made possible by the fastening construction 10 according to the disclosure herein. In particular, the external mark 130 in the form of a surface structure can also be integrated in the camouflage surface structure 140.

FIG. 4 is a schematic view of an opening device 20 according to one example embodiment of the disclosure herein.

The opening device 20 comprises two receiving elements 21, an electrical energy source 22 and an induction coil 23. The receiving elements 21 are designed to produce a detachable connection to a panel, in particular to a panel as shown in FIGS. 2 and 3. The induction coil 23 is connected to the electrical energy source 22 by an electrical connection 24. By this connection to the electrical energy source 22, the induction coil 23 of the opening device 23 can induce a current in an induction coil of a panel when the receiving elements 21 are connected to the panel.

By the opening device 20 shown here, the panel can be removed from and reinserted in a fastening construction as shown in FIG. 3. For this purpose, the opening device 20 can comprise a switching device (not shown) in order to produce a current pulse which can be induced in the panel through the induction coil 23 of the opening device 20. The opening device 20 can also comprise an ergonomically designed handle to simplify the handling of the opening device 20.

In the example embodiment shown here, the electrical energy source 22 is shown as a component of the opening device 20. For this purpose, for example a battery can be provided. It is also conceivable to provide an electrical energy source 22 externally to the opening device 20 and to connect the opening device 20 to an external electrical energy source 22 of this type for example by a cable.

The precise function of the receiving elements 21 is not shown here, since there are many design possibilities for these elements. By way of example, suction cups which receive the panel by a vacuum are conceivable. Other alternatives would also be hook or plug-in connections, or magnetic/electromagnetic connections. The number and the arrangement of the receiving elements 21 can also be selected as required.

The opening device 20 shown here additionally comprises a recess 25, which is used to align the opening device 20 in combination with the external mark, in the form of a surface structure, of the panel shown in FIG. 3.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 aircraft
10 fastening construction
20 opening device
21 receiving element
22 electrical energy source
23 induction coil
24 electrical connection
25 recess
100 panel
110 electro-permanent magnet
120 induction coil
121 electrical connection
130 external mark
140 camouflage surface structure
200 base element
210 ferromagnet

1. A panel comprising:
an electro-permanent magnet which is integrated in the panel; and
an induction coil which is connected to the electro-permanent magnet and is configured to conduct current induced in the induction coil to the electro-permanent magnet such that the electro-permanent magnet can be switched between a magnetic state and a non-magnetic state.

2. The panel according to claim 1, wherein the induction coil unit is integrated in the panel.

3. The panel according to claim 2, wherein the panel has an external mark which indicates a position of the induction coil.

4. The panel according to claim 3, wherein the external mark is in a form of a surface structure.

5. A fastening construction, comprising:
the panel according to claim 1; and
a base element having a ferromagnet configured to connect the panel to the base element when the electro-permanent magnet of the panel is in the magnetic state.

6. The fastening construction according to claim 5, wherein the base element has a recess which is adapted to the shape of the panel.

7. The fastening construction according to claim 6, wherein the recess is configured such that a surface of the panel is positively connected to a surface of the base element when the panel is arranged in the recess.

8. The fastening construction according to claim 7, wherein the surface of the panel and the surface of the base element have a camouflage surface structure.

9. An aircraft comprising the fastening construction according to claim 5.

10. An opening device for a panel according to claim 1, comprising:
at least one receiving element configured to produce a detachable connection to the panel;
an electrical energy source; and
an induction coil which is connected to the electrical energy source and is configured to induce a current in the induction coil of the panel when the at least one receiving element is connected to the panel.
